(19) United States
(12) Patent Application Publication
(10) Pub. No.: US 2026/0260241 A1
(43) Pub. Date: Sep. 3, 2026

(54) Decentralized Multi-System Cellular Architecture and Green, Sovereign Behavioral Currency System Based on a Multi-System Domain Token Infrastructure (24HWS / BEI System)

(71) Applicant: FURONG BEI, SAN GABRIEL, CA (US)

(72) Inventor: FURONG BEI, SAN GABRIEL, CA (US)

(21) Appl. No.: 19/177,252

(22) Filed: Apr. 11, 2025

(51) Int. Cl. G06Q 20/40; G06F 16/22

(52) U.S. Cl. CPC G06Q 20/4014; G06F 16/2264; G06Q 2220/00

(57) ABSTRACT

A sovereign time-behavior coordinate infrastructure generates multidimensional coordinate identifiers for subjects, devices, assets, services, and terminals using jurisdiction, trusted time-window, functional-domain, need-or-context, and scoped-node fields. A secured terminal supplies terminal attestation data, and a scoped-identity allocator assigns function-limited identity resources associated with a root identity. A Time-of-Time ledger verifies chained trusted time-window records, while a behavior-signal verifier produces privacy-preserving behavior-attestation states. A value-eligibility engine generates eligibility records for service authorization, asset tagging, mint eligibility, licensing, transfer, marketplace validation, audit, or revocation only when coordinate, terminal, scoped identity, time, and behavior rules are satisfied. Anti-replay and collision controls reject duplicate coordinates, replayed terminal proofs, and duplicated eligibility records. The infrastructure can reduce dependence on telephone numbers, SIM credentials, bank routing identifiers, or GPS-dependent references as controlling identity or eligibility references.

### FIELD OF THE INVENTION

The disclosure relates to computer-implemented identity infrastructure, terminal attestation, trusted time-window processing, behavior-signal verification, scoped identity allocation, asset tagging, and value-eligibility control. More particularly, the disclosure concerns a sovereign time-behavior coordinate architecture in which a secured terminal, a multidimensional coordinate identifier, a time-of-time ledger, and a value-eligibility engine cooperate to produce privacy-preserving identity, asset, service, licensing, transfer, and audit outputs.

The technical field includes distributed identity management, coordinate addressing. secure terminal devices, cryptographic time attestation, collision-resistant namespace allocation, privacy-preserving behavioral attestation, anti-replay processing, asset registry integration, licensing package generation, and transfer-eligibility control. Implementations may operate in communication networks, health-service networks, marketplace platforms, sovereign identity systems, enterprise workflows, asset registries, wallets, data vaults, or cross-chain infrastructure.

Non-limiting implementation examples may use 24HWS, BEI, BEIDID, BEIEID. BehaviorID, ReadName Token Terminal, Time-of-Time Ledger, ToT Ledger, Time ID, Time Identity, and equivalent names, portals, application endpoints, ledger endpoints, identity endpoints, terminal endpoints, proof endpoints, marketplace endpoints, asset endpoints, or service endpoints. These examples are illustrative only and do not limit the claimed invention to a particular brand, domain name, website, token name, endpoint provider, or deployment architecture

### BACKGROUND

Conventional identity systems frequently depend on disconnected identifiers such as telephone numbers, SIM credentials, account names, bank routing codes, device identifiers, wallet addresses, platform logins, and location records. These identifiers are not generated under a common technical coordinate model and are often not linked to trusted time windows, scoped identity resources, terminal attestation, behavior-state verification, and revocation logic.

A conventional digital wallet may verify possession of a private key without proving that the device, terminal, person, service context, and time window satisfy an integrated eligibility rule. A conventional communication account may route messages without producing an asset-tagging instruction, licensing package, transfer package, or revocation-safe audit record. A conventional registry may store an asset or patent record without allocating a bounded identity scope or validating the terminal that originated the record.

Existing systems also create overbroad or unsafe identity surfaces. A single account can be used across medical, financial, communication, educational, enterprise, and marketplace contexts, causing privacy leakage, unauthorized reuse, and weak revocation. A need exists for scoped identity resources that can be separately assigned, suspended, licensed, transferred, revoked, expired, or closed according to context-specific rules.

Time is also fragmented. A server timestamp, blockchain timestamp, local device time, calendar period, billing cycle, session marker, sensor interval, or regulatory deadline can each exist in a different silo. A technical infrastructure is needed that binds terminal activity, scoped identity, and value eligibility to chained trusted time-window records so that replay, double issuance, stale authorizations, and duplicate asset records can be rejected.

Behavioral and biometric signals may be valuable for liveness, possession, continuity, service eligibility, fraud resistance, and terminal authorization, but raw biometric or emotional data should not be exposed to marketplaces, licensees, asset buyers, or downstream services. A technical solution is needed that can derive behavior-attestation states and value-eligibility records without disclosing raw private signals.

The present disclosure addresses these problems using a coordinate-identifier generator, secured terminal, scoped-identity allocator, time-of-time ledger interface, behavior-signal verifier, value-eligibility engine, and anti-replay and collision controller. Existing telephone-number, SIM-based, bank-code-based, and GPS-dependent systems can identify communication subscriptions, financial routes, or geographic locations, but they do not provide a unified machine-verifiable structure for binding a subject, terminal, scoped identity, trusted time window, behavior signal, value-eligibility state, revocation state, and audit trail. A technical need exists for an infrastructure that can reduce or bypass dependence on those legacy identifiers when identity, authorization, service proof, asset tagging, licensing, transfer, or settlement decisions are required.

### SUMMARY OF THE INVENTION

In one aspect, the disclosed infrastructure provides a patent-protectable time-identity and terminal-attested value-eligibility architecture that can reduce or bypass dependence on telephone numbers, SIM credentials, bank routing identifiers, and GPS-dependent location references for identity, authorization, service proof, asset tagging, licensing, transfer, and settlement. The infrastructure does not require any particular carrier number, SIM credential, bank code, or GPS coordinate to serve as the root identity or controlling value-eligibility reference. A computer-implemented system generates multidimensional coordinate identifiers for subjects, devices, assets, services, and terminals. Each coordinate identifier may include a jurisdiction field, trusted time-window field, functional-domain field, need-or-context field, and scoped node field.

A secured terminal, such as a ReadName Token Terminal or equivalent attested terminal, provides terminal attestation data. The terminal attestation data may include a terminal identifier, device certificate, secure-enclave attestation, terminal time proof, sensor proof, public key, passkey proof, or terminal counter. The secured terminal may operate as an identity vault, communication endpoint, service terminal, asset-origin terminal, medical terminal, wallet terminal, or licensing terminal.

A scoped-identity allocator assigns function-limited identity resources associated with a root identity or coordinate identifier. In certain embodiments, up to nine hundred ninety-nine scoped identity resources may be allocated to a root identity, with each resource having its own function, service, domain, asset class, lifecycle state, policy, and revocation rule.

A time-of-time ledger interface stores or verifies a chained sequence of trusted time-window records. The time-of-time ledger need not be a public blockchain. It may be a database ledger, private ledger, distributed ledger hardware-backed log, enterprise audit chain, append-only log, notary service, or hybrid ledger that stores time-window hashes, prior-window hashes, terminal signatures, policy versions, and coordinate-reference hashes.

A behavior-signal verifier derives a behavior-attestation state from one or more sensor signals, biometric signals, activity signals, terminal-use signals, communication signals, service signals, or cryptographically signed user actions. The verifier may output a confidence score, liveness result, possession result, continuity result, anomaly score, or eligibility state while preventing raw biometric data or raw emotional data from being transmitted to downstream market or licensing systems.

A value-eligibility engine generates a technical value-eligibility record only when the coordinate identifier, terminal attestation data, scoped identity resource, trusted time-window record, and behavior-attestation state satisfy machine-readable eligibility rules. The value-eligibility record may be a non-currency authorization record that later permits a minting, service-credit, licensing, transfer, settlement, exchange, registry, marketplace, or index operation.

The system includes anti-replay and collision controls to reject duplicate coordinates, duplicate scoped-identity issuance, replayed terminal time proofs, duplicated terminal counters, conflicting asset bindings, or duplicate value-eligibility records. These controls provide a technical effect of reducing inconsistent computer states and preventing multiple downstream systems from accepting the same terminal proof or identity resource.

The output interface may transmit identity-vault records, asset-tagging instructions, communication-routing instructions, service-authorization instructions, mint-eligibility instructions, licensing packages, transfer packages, marketplace-listing signals, audit records, index signals, and revocation signals. The outputs may be used in asset packages, licensing negotiations, marketplace listings, medical or communication networks, and enterprise identity systems.

### BRIEF DESCRIPTION OF THE DRAWINGS

FIG. 1 illustrates an overall sovereign time-behavior coordinate infrastructure.

FIG. 2 illustrates a multidimensional coordinate identifier field generation process.

FIG. 3 illustrates scoped identity allocation from a root identity to function-limited scoped identity resources.

FIG. 4 illustrates a secured terminal or ReadName Token Terminal attestation interface.

FIG. 5 illustrates a value-eligibility engine and eligibility-rule decision process.

FIG. 6 illustrates binding of a coordinate identifier, terminal attestation, behavior signal, trusted time-window record, and Time-of-Time ledger audit record.

FIG. 7 illustrates scoped identity lifecycle control including grant, revocation, expiration, renewal, and lifecycle record generation.

FIG. 8 illustrates behavior-signal verification, confidence-threshold processing, insufficient state handling, and behavior-attested state output.

FIG. 9 illustrates coordinate collision checking and duplicate-coordinate rejection or revision.

FIG. 10 illustrates output routing for identity-vault records, asset-tagging instructions, service authorization, mint-eligibility instructions, licensing packages, transfer packages, audit records, and marketplace or settlement signals.

FIG. 11 illustrates allocation of up to nine hundred ninety-nine scoped resources from a root identity.

FIG. 12 illustrates service authorization within a bounded validity window.

FIG. 13 illustrates medical or health-service terminal integration.

FIG. 14 illustrates coordinate endpoint routing and scoped communication authorization.

FIG. 15 illustrates wallet or terminal authorization using policy, key-store, signature validation, and scope validation.

FIG. 16 illustrates anti-replay and duplicate-value-event control using hash, nonce, prior ledger state, and identity collision checking.

FIG. 17 illustrates authorization, transfer, revocation window, final state, and immutable audit trail processing.

FIG. 18 illustrates an end-to-end operating sequence from coordinate input through terminal proof, policy context, scoped identity, behavior verification, Time-of-Time ledger window, anti-replay check, value eligibility, and license-transfer audit.

### DETAILED DESCRIPTION

The following description provides non-limiting embodiments. The modules, data structures, and operations may be implemented by one or more processors, secure terminals, mobile devices, servers, cloud services, hardware security modules, secure enclaves, databases, ledgers, message queues, application programming interfaces, smart contracts, or combinations thereof.

The disclosed infrastructure is not merely the use of a computer to perform a commercial arrangement. The system requires specific data-object transformations and state transitions: coordinate generation, terminal attestation verification, scoped identity allocation, trusted time-window binding, behavior-state derivation, eligibility-rule evaluation, duplicate rejection, and privacy-preserving output generation.

The architecture may be deployed as an independent asset platform or as a component in an asset package. It may protect identity issuance, terminal validation, time-ledger verification, behavior-attestation, asset tagging, service authorization, licensing, transfer, marketplace listing, and audit functions that can be licensed separately or together.

### Coordinate-Identifier Generator

The coordinate-identifier generator receives source fields and normalizes them into a structured coordinate identifier. The fields may include jurisdiction, time-window, functional-domain, need-or-context, and scoped node fields. Optional fields may include language, institution, enterprise, device class, service class, asset class, clinical context, communication type, and regulatory context.

A collision-resistant hash, checksum, namespace proof, or registry lookup may be used to determine whether the proposed coordinate conflicts with an existing coordinate. If a conflict exists, the generator may derive an alternate scoped node field or reject the request. The generator may output both a human-readable coordinate string and a machine-readable coordinate object.

In certain embodiments, the coordinate functions as a digital address or technical eligibility reference that can operate in place of, or in addition to, a telephone number, SIM credential, account name, wallet address, bank routing code, platform handle, or GPS-dependent location reference. The coordinate is not merely a label; it can be resolved to policy, identity scope, terminal state, time-window validity, value-eligibility status, and revocation conditions.

In implementations of the coordinate-identifier generator module, data may be transmitted by API call, secure channel, message queue, event bus, smart contract call, database transaction, terminal message, hardware attestation message, or equivalent machine communication. The implementation form is not limiting when the claimed technical states and data objects are present.

The output of the coordinate-identifier generator module may be consumed by one or more downstream modules in a state-dependent manner. For example, a value-eligibility output may be unavailable until terminal attestation and time-window checks are complete, and a licensing package may be unavailable until anti-replay and lifecycle checks are satisfied.

### Secured Terminal and ReadName Token Terminal Embodiments

The secured terminal may include a processor, memory, cryptographic key store, secure enclave, trusted clock, biometric sensor interface, network interface, display, input device, and local identity vault. The terminal may generate signed terminal proofs without exposing raw private data.

A ReadName Token Terminal may serve as a non-limiting secured terminal embodiment. It may operate as a communication node, identity vault, asset-origin terminal, medical terminal, wallet terminal, service terminal, or licensing terminal. The same physical terminal may support multiple scoped identity resources while enforcing policy separation among them.

The terminal may include a terminal counter and monotonic time proof. The counter and time proof are included in attestation payloads so that a server or ledger can reject replayed proofs. The terminal may also generate compromise notices when secure-enclave failure, sensor tampering, policy expiration, or unauthorized reset is detected.

In implementations of the secured terminal and readname token terminal embodiments module, data may be transmitted by API call, secure channel, message queue, event bus, smart contract call, database transaction, terminal message, hardware attestation message, or equivalent machine communication. The implementation form is not limiting when the claimed technical states and data objects are present.

The output of the secured terminal and readname token terminal embodiments module may be consumed by one or more downstream modules in a state-dependent manner. For example, a value-eligibility output may be unavailable until terminal attestation and time-window checks are complete, and a licensing package may be unavailable until anti-replay and lifecycle checks are satisfied.

### Scoped Identity Allocation

The scoped-identity allocator creates bounded identity resources associated with a root identity, coordinate identifier, terminal, or asset. A scoped identity resource is not a general account credential. It is restricted to a defined function, domain, service, asset class, transaction class, communication context, medical context, licensing context, or authorization context.

In one embodiment, a root identity may receive up to nine hundred ninety-nine scoped identity resources. Each resource may have a resource number, functional domain, issuance timestamp, expiration rule, revocation rule, transfer rule, licensing rule, and audit pointer. The numerical upper bound is an implementation example that provides a large but finite identity space.

Scoped identity resources may reduce privacy leakage by avoiding repeated use of one universal identifier across unrelated contexts. For example, a medical-service scoped identity may not reveal a marketplace identity, and an asset-licensing identity may not reveal a communication identity.

In implementations of the scoped identity allocation module, data may be transmitted by API call, secure channel, message queue, event bus, smart contract call, database transaction, terminal message, hardware attestation message, or equivalent machine communication. The implementation form is not limiting when the claimed technical states and data objects are present.

The output of the scoped identity allocation module may be consumed by one or more downstream modules in a state-dependent manner. For example, a value-eligibility output may be unavailable until terminal attestation and time-window checks are complete, and a licensing package may be unavailable until anti-replay and lifecycle checks are satisfied.

### Time-of-Time Ledger Interface

The time-of-time ledger interface stores or verifies chained trusted time-window records. Each record may include a time-window identifier, prior-window hash, coordinate-reference hash, terminal signature, terminal counter, policy version, ledger timestamp, and audit pointer.

The time-of-time ledger may be implemented as an append-only database, blockchain, notary log, distributed ledger, hardware-backed clock chain, enterprise audit chain, or hybrid system. The ledger is not required to move currency. Its technical function is to bind terminal proofs and scoped identity states to verifiable time windows.

A time-window record may establish a validity period for service authorization, asset tagging, identity assertions, mint eligibility, licensing rights, transfer packages, marketplace listing, or revocation. Expired windows may be rejected by the anti-replay controller.

In implementations of the time-of-time ledger interface module, data may be transmitted by API call, secure channel, message queue, event bus, smart contract call, database transaction, terminal message, hardware attestation message, or equivalent machine communication. The implementation form is not limiting when the claimed technical states and data objects are present.

The output of the time-of-time ledger interface module may be consumed by one or more downstream modules in a state-dependent manner. For example, a value-eligibility output may be unavailable until terminal attestation and time-window checks are complete, and a licensing package may be unavailable until anti-replay and lifecycle checks are satisfied.

### Behavior-Signal Verifier

The behavior-signal verifier receives or derives data from sensors, biometric inputs, activity logs, device-possession proofs, communication events, service events, or signed user actions. The verifier may derive a behavior-attestation state rather than publishing raw signal data.

Inputs may include liveness result, terminal possession result, activity continuity, trusted user gesture, motion pattern, service completion status, voice or face liveness score, keyboard interaction state, wearable sensor state, or a zero-knowledge proof of a private event. The system may use any subset appropriate for the functional domain.

The verifier may output allow, deny, escalate, review, restricted, proof-only, or eligible states. It may also output a confidence score and anomaly score. The confidence score or behavior-attestation state may be generated by a deterministic, probabilistic, cryptographic, hardware-based, rule-based, threshold-based, fuzzy-logic, statistical, graph-based, machine-learning, or hybrid verification technique, and is not limited to any particular forecasting model or training architecture. A behavior-attestation state machine may include states such as unverified, terminal-attested, time-window-valid, behavior-consistent, confidence-threshold-satisfied, eligible, denied, restricted, revoked, expired, or disputed. Raw biometric or emotional information can remain in a terminal vault or encrypted vault while downstream systems receive only the derived attestation state.

In implementations of the behavior-signal verifier module, data may be transmitted by API call, secure channel, message queue, event bus, smart contract call, database transaction, terminal message, hardware attestation message, or equivalent machine communication. The implementation form is not limiting when the claimed technical states and data objects are present.

The output of the behavior-signal verifier module may be consumed by one or more downstream modules in a state-dependent manner. For example, a value-eligibility output may be unavailable until terminal attestation and time-window checks are complete, and a licensing package may be unavailable until anti-replay and lifecycle checks are satisfied.

### Value-Eligibility Engine

The value-eligibility engine evaluates coordinate, terminal, identity, time, and behavior inputs against policy rules. The engine may generate a value-eligibility record only after all required technical predicates are satisfied. This requirement prevents value-related outputs from being generated from unverified identity or replayed terminal proofs.

A value-eligibility record may authorize a later minting instruction, service credit, communication credit, medical service unit, asset license, asset transfer, marketplace listing, settlement instruction, or index update. The record may be non-transferable, transferable, proof-only, restricted, time-limited, asset-bound, domain-bound, or terminal-bound.

The engine may separate technical eligibility from legal tender movement. For example, an eligibility record may indicate that a user or terminal has satisfied proof requirements for a later transaction, without itself transferring money. This separation helps integrate with regulated payment systems and asset registries.

In implementations of the value-eligibility engine module, data may be transmitted by API call, secure channel, message queue, event bus, smart contract call, database transaction, terminal message, hardware attestation message, or equivalent machine communication. The implementation form is not limiting when the claimed technical states and data objects are present.

The output of the value-eligibility engine module may be consumed by one or more downstream modules in a state-dependent manner. For example, a value-eligibility output may be unavailable until terminal attestation and time-window checks are complete, and a licensing package may be unavailable until anti-replay and lifecycle checks are satisfied.

### Anti-Replay and Collision Controller

The anti-replay and collision controller prevents duplicate coordinate assignment, duplicate scoped identity issuance, replayed terminal time proofs, reused nonces, duplicated terminal counters, conflicting asset bindings, and repeated value-eligibility outputs.

The controller may maintain consumed-proof states and reject attempts to reuse a terminal proof outside its permitted time window. It may also compare coordinate hashes, identity-resource states, terminal counters, ledger references, and policy versions before authorizing any output.

When a conflict is detected, the controller may output quarantine, deny, revoke, delay, review, correction-required, or replacement-coordinate states. These states are machine-enforced and may be recorded in an audit log.

In implementations of the anti-replay and collision controller module, data may be transmitted by API call, secure channel, message queue, event bus, smart contract call, database transaction, terminal message, hardware attestation message, or equivalent machine communication. The implementation form is not limiting when the claimed technical states and data objects are present.

The output of the anti-replay and collision controller module may be consumed by one or more downstream modules in a state-dependent manner. For example, a value-eligibility output may be unavailable until terminal attestation and time-window checks are complete, and a licensing package may be unavailable until anti-replay and lifecycle checks are satisfied.

### Identity Vault and Privacy Controls

The identity vault may store root identity data, scoped identity resource records, encrypted payloads, biometric templates, device certificates, terminal keys, credential references, policy tables, and audit pointers. The vault may be terminal-local, server-side, distributed, or hybrid.

Privacy controls may include encryption, secure enclave storage, hardware security modules, selective disclosure credentials, zero-knowledge commitments, payload masking, redacted evidence packages, role-based access, and jurisdiction-specific retention rules.

A downstream licensee or marketplace may validate a value-eligibility record through a hash, signature, or API response without obtaining raw biometric data, raw emotion data, medical data, or private terminal payloads.

In implementations of the identity vault and privacy controls module, data may be transmitted by API call, secure channel, message queue, event bus, smart contract call, database transaction, terminal message, hardware attestation message, or equivalent machine communication. The implementation form is not limiting when the claimed technical states and data objects are present.

The output of the identity vault and privacy controls module may be consumed by one or more downstream modules in a state-dependent manner. For example, a value-eligibility output may be unavailable until terminal attestation and time-window checks are complete, and a licensing package may be unavailable until anti-replay and lifecycle checks are satisfied.

### Asset Tagging and Registry Integration

The output interface may generate asset-tagging instructions that bind patents, patent disclosures, technical documents, communication endpoints, service records, digital assets, domain assets, health-record pointers, and terminal records to coordinate identifiers.

An asset-tagging instruction may include an asset pointer, coordinate reference, scoped identity resource, time-window proof, terminal-attestation hash, value-eligibility state, revocation rule, and audit pointer. The instruction may be transmitted to a registry, marketplace, licensing platform, or enterprise asset system.

The asset may be fungible, non-fungible, transferable, non-transferable, divisible licensed, restricted, confidential, or proof-only. The system can tag assets without requiring that every tagged asset become a currency or token.

In implementations of the asset tagging and registry integration module, data may be transmitted by API call, secure channel, message queue, event bus, smart contract call, database transaction, terminal message, hardware attestation message, or equivalent machine communication. The implementation form is not limiting when the claimed technical states and data objects are present.

The output of the asset tagging and registry integration module may be consumed by one or more downstream modules in a state-dependent manner. For example, a value-eligibility output may be unavailable until terminal attestation and time-window checks are complete, and a licensing package may be unavailable until anti-replay and lifecycle checks are satisfied.

### Licensing and Transfer Package Generation

The licensing package may include a coordinate reference, scoped identity resource, asset pointer, value-eligibility state, time-window proof, rights description, license scope, territory, duration, field-of-use, sublicensing rule, audit requirement, and revocation condition.

The transfer package may include seller identity scope, buyer identity scope, asset pointer, terminal attestation hash, time-window proof, consumed-proof state, anti-duplication check, transfer restriction, and finality condition. These data objects can be exported for negotiation, due diligence, valuation, and closing.

Because the licensing package and transfer package are generated from technical proofs and scoped states, the asset package may obtain greater reliability and transaction value than a document-only registry entry.

In implementations of the licensing and transfer package generation module, data may be transmitted by API call, secure channel, message queue, event bus, smart contract call, database transaction, terminal message, hardware attestation message, or equivalent machine communication. The implementation form is not limiting when the claimed technical states and data objects are present.

The output of the licensing and transfer package generation module may be consumed by one or more downstream modules in a state-dependent manner. For example, a value-eligibility output may be unavailable until terminal attestation and time-window checks are complete, and a licensing package may be unavailable until anti-replay and lifecycle checks are satisfied.

### Service Authorization and Communication Routing

A service-authorization instruction may authorize access to a medical service, communication session, enterprise workflow, educational service, asset repository, terminal function, or marketplace operation. The instruction may be bounded by a time window and a scoped identity resource.

A communication-routing instruction may route messages, calls, AI-agent actions, terminal signals, service requests, asset requests, licensing requests, or settlement requests using the coordinate identifier in place of, or in addition to, a traditional phone number, SIM credential, bank routing identifier, platform handle, wallet address, or GPS-dependent location reference.

The routing instruction may reference an endpoint resolver, privacy policy, terminal state, trusted time-window record, scoped identity resource, and eligibility rule.

The system may provide revocation and correction signals when an authorization has expired, a terminal is compromised, a scoped identity is suspended, or an anti-replay rule rejects a request.

In implementations of the service authorization and communication routing module, data may be transmitted by API call, secure channel, message queue, event bus, smart contract call, database transaction, terminal message, hardware attestation message, or equivalent machine communication. The implementation form is not limiting when the claimed technical states and data objects are present.

The output of the service authorization and communication routing module may be consumed by one or more downstream modules in a state-dependent manner. For example, a value-eligibility output may be unavailable until terminal attestation and time-window checks are complete, and a licensing package may be unavailable until anti-replay and lifecycle checks are satisfied.

### Medical and Health-Service Embodiments

In medical embodiments, a patient, provider, device, service, or medical asset may receive a coordinate identifier and scoped identity resource. A secured terminal may verify terminal possession, device certificate, time window, and sensor status before issuing a medical service authorization.

The system may avoid exposing raw medical data to a marketplace or unrelated service by transmitting only a privacy-preserving value-eligibility or service-authorization state. A medical record pointer may remain encrypted in a vault and may be referenced by a coordinate hash and audit pointer.

This embodiment is useful for medicalcenter.us, telehealth minutes, medical behavior segmentation, and clinical service authorization, but the claims do not require any particular medical portal or branded service.

In implementations of the medical and health-service embodiments module, data may be transmitted by API call, secure channel, message queue, event bus, smart contract call, database transaction, terminal message, hardware attestation message, or equivalent machine communication. The implementation form is not limiting when the claimed technical states and data objects are present.

The output of the medical and health-service embodiments module may be consumed by one or more downstream modules in a state-dependent manner. For example, a value-eligibility output may be unavailable until terminal attestation and time-window checks are complete, and a licensing package may be unavailable until anti-replay and lifecycle checks are satisfied.

### Communication and Behavioral Economy Embodiments

A communication event may create a service signal, behavior signal, or terminal-use signal. The behavior-signal verifier may derive a behavior-attestation state from such event without treating the message content itself as a public asset.

A behavioral economy embodiment may issue a mint-eligibility instruction when verified time, terminal attestation, scoped identity, and behavior-attestation rules are satisfied. The system may also output proof-only records or non-transferable reputation records when policy does not permit minting or transfer.

The invention does not require proof-of-work mining. Eligibility may be based on attested time windows and verified behavior states. This provides a technical alternative to energy-intensive minting while maintaining anti-replay and auditability controls.

In implementations of the communication and behavioral economy embodiments module, data may be transmitted by API call, secure channel, message queue, event bus, smart contract call, database transaction, terminal message, hardware attestation message, or equivalent machine communication. The implementation form is not limiting when the claimed technical states and data objects are present.

The output of the communication and behavioral economy embodiments module may be consumed by one or more downstream modules in a state-dependent manner. For example, a value-eligibility output may be unavailable until terminal attestation and time-window checks are complete, and a licensing package may be unavailable until anti-replay and lifecycle checks are satisfied.

### Cross-Chain and External Validation

The system may expose an application programming interface through which a third-party chain, wallet, exchange, marketplace, registry, or enterprise system verifies a value-eligibility record. The API may return valid, invalid, expired, revoked, restricted, duplicate, or review-required states.

A non-fungible reputation token, credential, or registry record may be generated to represent a scoped identity state or eligibility proof. The token or record may reference a coordinate hash and time-window proof without containing private raw signals.

External validation allows interoperability while preserving separation between the technical eligibility system and regulated financial, securities, insurance, health, or telecommunications systems.

In implementations of the cross-chain and external validation module, data may be transmitted by API call, secure channel, message queue, event bus, smart contract call, database transaction, terminal message, hardware attestation message, or equivalent machine communication. The implementation form is not limiting when the claimed technical states and data objects are present.

The output of the cross-chain and external validation module may be consumed by one or more downstream modules in a state-dependent manner. For example, a value-eligibility output may be unavailable until terminal attestation and time-window checks are complete, and a licensing package may be unavailable until anti-replay and lifecycle checks are satisfied.

### Revocation, Correction, and Lifecycle State Control

Each scoped identity resource and eligibility record may have a lifecycle state. States may include pending, active, restricted, suspended, revoked, expired, transferred, licensed, disputed, corrected, settled final, or closed.

A revocation signal may be generated when terminal compromise, sensor failure, policy expiration, identity conflict, jurisdictional order, duplicate proof, or unauthorized replay is detected. Revocation may affect one scoped identity without disabling all other scoped identities associated with a root identity.

A correction record may preserve an audit trail and identify the reason for correction, replacement coordinate, replacement terminal, replacement policy version, or corrected time window. Hidden alteration can be prevented by linking the correction to the prior proof state.

In implementations of the revocation, correction, and lifecycle state control module, data may be transmitted by API call, secure channel, message queue, event bus, smart contract call, database transaction, terminal message, hardware attestation message, or equivalent machine communication. The implementation form is not limiting when the claimed technical states and data objects are present.

The output of the revocation, correction, and lifecycle state control module may be consumed by one or more downstream modules in a state-dependent manner. For example, a value-eligibility output may be unavailable until terminal attestation and time-window checks are complete, and a licensing package may be unavailable until anti-replay and lifecycle checks are satisfied.

### EXAMPLE OPERATING SEQUENCES

### Example—Coordinate Issuance

A terminal receives a request to create a coordinate for a new service context. The generator receives jurisdiction, time-window, functional-domain, need-or-context, and scoped node fields; validates field syntax; checks for collision; generates a coordinate hash; and stores a pending coordinate state. After terminal attestation is validated, the coordinate becomes active.

The example is non-limiting. Alternative deployments may use different terminal hardware, ledger technology, field names, asset classes, or validation endpoints while preserving the same coordinate, terminal, time, identity, behavior, eligibility, and anti-replay relationship.

### Example—Scoped Identity Allocation

A root identity requests a medical service identity. The allocator verifies policy, assigns a scoped identity number, binds the identity to a medical functional domain, records a lifecycle state, and stores a revocation condition. The medical scoped identity may be used without revealing marketplace or communication identities.

The example is non-limiting. Alternative deployments may use different terminal hardware, ledger technology, field names, asset classes, or validation endpoints while preserving the same coordinate, terminal, time, identity, behavior, eligibility, and anti-replay relationship.

### Example—Value Eligibility

A secured terminal signs a time proof and submits a behavior-state proof. The time-of-time ledger validates the current time window, the behavior-signal verifier derives an eligible state, and the value-eligibility engine generates a mint-eligibility instruction or service-credit eligibility record. If the same proof is replayed, the anti-replay controller rejects it.

The example is non-limiting. Alternative deployments may use different terminal hardware, ledger technology, field names, asset classes, or validation endpoints while preserving the same coordinate, terminal, time, identity, behavior, eligibility, and anti-replay relationship.

### Example—Asset Licensing

A patent disclosure asset is tagged with a coordinate reference and scoped identity resource. A licensing package is generated that includes an asset pointer, rights scope, time-window proof, terminal attestation hash, and revocation rule. A potential licensee validates the package through an API without viewing raw biometric or private terminal data.

The example is non-limiting. Alternative deployments may use different terminal hardware, ledger technology, field names, asset classes, or validation endpoints while preserving the same coordinate, terminal, time, identity, behavior, eligibility, and anti-replay relationship.

### Example—Terminal Compromise

A terminal reports compromise or fails secure-enclave attestation. The system updates the terminal state to compromised, suspends affected scoped identities, revokes open eligibility records, emits a revocation signal, and preserves the prior proof state for audit review.

The example is non-limiting. Alternative deployments may use different terminal hardware, ledger technology, field names, asset classes, or validation endpoints while preserving the same coordinate, terminal, time, identity, behavior, eligibility, and anti-replay relationship.

### TECHNICAL ADVANTAGES

The system improves computer identity infrastructure by generating bounded coordinate identifiers and scoped identity resources rather than relying on a single unbounded account identifier. The infrastructure can also improve identity, authorization, service proof, asset tagging, licensing, transfer, and settlement operations by reducing or bypassing dependence on telephone numbers. SIM credentials, bank routing identifiers, or GPS-dependent location references as controlling root identifiers.

The system improves terminal security by requiring terminal attestation and terminal time proofs before identity or value-eligibility outputs are generated.

The system improves distributed time consistency by chaining trusted time-window records in a time-of-time ledger.

The system improves privacy by deriving behavior-attestation states and eligibility records without transmitting raw biometric, emotional, medical, or private terminal payloads to downstream systems.

The system improves anti-duplication by rejecting duplicate coordinate assignments, duplicate scoped-identity issuance, replayed terminal proofs, and duplicate eligibility records.

The system improves transaction reliability by producing licensing packages, transfer packages, marketplace signals, and audit records that are bound to coordinate, time, identity. terminal, and behavior states.

### DISTINCTIONS FROM CONVENTIONAL SYSTEMS

### Difference from Telephone and SIM Systems

A conventional telephone or SIM system may identify a subscriber, carrier account, mobile device, or network subscription. Such systems do not necessarily generate a time-window-bound coordinate identity, verify terminal attestation, allocate function-limited scoped identities, bind behavior signals to a time-of-time ledger, generate value-eligibility records, or control revocation and finality for licensing, transfer, service proof, or settlement. The disclosed infrastructure can therefore reduce or bypass dependence on telephone numbers or SIM credentials for identity and authorization operations, while still permitting interoperability with telephone or carrier systems when desired.

### Difference from GPS and Location Systems

A GPS or location system may determine or estimate geographic position. The disclosed infrastructure is not limited to determining where a terminal is located. Instead, it determines whether a subject, terminal, scoped identity, trusted time window, behavior signal, and policy rule collectively satisfy a technical eligibility condition. Accordingly, identity, authorization, service proof, asset tagging, licensing, transfer, or settlement may be performed without requiring a GPS-dependent location reference as the primary proof mechanism.

### Difference from Wallet Systems

A wallet may prove key possession or transfer tokens, but it does not necessarily verify terminal attestation, scoped identity status, trusted time windows, behavior-state eligibility, and anti-replay state before outputting licensing, transfer, marketplace, or audit packages.

### Difference from Publication Registries

A registry may store a document or asset record, but it does not provide the integrated coordinate, terminal, scoped identity, time ledger, behavior attestation, eligibility, collision control, and privacy-preserving validation workflow described here.

### Difference from Abstract Financial Concepts

The disclosed system does not claim a desired result of currency issuance or resource allocation alone. It defines specific computer modules, data objects, technical proofs, state transitions, and rejection logic that are required before eligibility outputs can be generated.

### NON-LIMITING IMPLEMENTATION EXAMPLES

Non-limiting endpoint and ecosystem examples may include 24HWS, BEI, BEIDID, BEIEID, BehaviorID, BEI.app, ATMS, BEIGX, BEISX, BEIIndex, BEIPROOF, BEIMINT, MedicalCenter.us, 120.us, time-domain services, registry systems, wallet systems, health-service systems, communication systems, and enterprise identity systems.

These examples may serve as coordinate namespaces, identity anchors, terminal interfaces, proof services, value-eligibility engines, marketplaces, licensing portals, audit endpoints, or revocation services. The technical invention is not limited to any listed domain, website, brand, token, or portal.

A third party may implement the same claimed infrastructure using different names, devices, chains, ledgers, identity providers, registries, or marketplaces if the system performs the claimed coordinate generation, terminal attestation, scoped identity allocation, time-window binding, behavior-state derivation, eligibility generation, anti-replay rejection, and output transmission.

### CLAIM SUPPORT AND ALTERNATIVE EMBODIMENTS

In support of claim 1, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 2, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 3, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 4, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 5, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 6, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 7, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 8, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 9, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 10, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 11, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 12, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 13, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 14, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 15, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 16, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 17, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 18, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 19, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

In support of claim 20, the corresponding elements may be implemented in hardware, software, firmware, a secure terminal, a server cluster, a cloud service, an enterprise service bus, a distributed ledger, an append-only database, a hardware security module, a mobile device, or a hybrid combination. Optional examples described in this specification are illustrative and do not narrow the claim unless expressly recited.

### CONCLUSION

The disclosed infrastructure provides a hard technical layer that can be licensed at multiple points: coordinate issuance, secured terminal attestation, scoped identity allocation, time-of-time ledger validation, behavior-state verification, value-eligibility generation, asset tagging, licensing package generation, transfer package generation, marketplace validation, and revocation/audit control.

The architecture is suitable for inclusion in an intellectual-property asset package because it protects not merely a brand or broad economic concept, but a sequence of technical gates that a downstream system must pass before identity, service, asset, licensing, transfer, mint-eligibility, marketplace, or audit outputs are generated.

Although particular embodiments have been described, the scope of protection is defined by the claims. Elements described in different embodiments may be combined unless the context requires otherwise.

### ADDITIONAL DETAILED EMBODIMENTS AND CLAIM SUPPORT

### Coordinate Field Encoding

The jurisdiction field may be a country code, regional code, sovereign code, enterprise jurisdiction, medical network code, registry jurisdiction, or neutral namespace code. A jurisdiction field can be used without revealing precise physical location.

The trusted time-window field may represent a year, month, day, hour, minute, session interval, billing interval, service interval, medical encounter interval, asset-licensing interval, or policy-defined interval.

The functional-domain field may represent communication, medicine, education, finance, asset registry, intellectual property, marketplace, enterprise workflow, identity vault, terminal operation, or a special-purpose domain.

The need-or-context field may represent a user need, service category, resource class, emergency level, clinical context, asset class, behavioral state category, or business-process state.

The scoped node field may be a counter, pseudonymous identifier, terminal-generated node value, asset node, user node, organization node, device node, or application node.

A check digit, collision-resistance hash, prefix, suffix, or registry-specific checksum may be appended to the coordinate identifier to reduce transcription errors and prevent duplicate issuance.

The coordinate identifier may be stored in canonical form and displayed in a shortened form. A canonical form may include all field values, while a display form may conceal sensitive fields.

A resolver may map the coordinate identifier to a current endpoint, policy, service, asset pointer, or licensing record without requiring that the coordinate itself contain the endpoint address.

The embodiments described in this section may be combined with any other embodiment described herein unless the combination is technically impossible. Field names, terminal names, endpoint names, and branded names are examples and may be replaced by equivalent machine-readable identifiers.

A claim element corresponding to this section may be implemented as software instructions, hardware circuitry, firmware, a terminal module, a server module, a database table, a ledger entry, an API endpoint, or a distributed combination thereof.

### Terminal Attestation Payloads

A terminal attestation payload may include a terminal identifier, public key, certificate chain, secure-enclave quote, terminal firmware measurement, sensor module measurement, trusted clock proof, monotonic counter, nonce, and policy version.

The terminal may sign the attestation payload with a terminal private key stored in a secure enclave or hardware security module. A server may verify the signature before accepting any coordinate, identity, or value-eligibility request.

A terminal may be portable, wearable, mobile, embedded in an appliance, embedded in a vehicle, installed in a medical facility, integrated into an ATM-like device, or implemented as an AI-agent terminal.

The terminal may maintain separate local vault compartments for different scoped identity resources. For example, a medical scoped identity vault may be separated from a marketplace scoped identity vault.

A terminal time proof may be generated from a trusted clock, ledger timestamp, server challenge, secure enclave counter, synchronized network time, or hybrid proof.

The terminal may generate a compromise signal when a cryptographic key is rotated unexpectedly, a secure boot measurement changes, a sensor is removed, or a clock rollback is detected.

A terminal may produce an attestation proof without transmitting raw fingerprint, face, voice, heart-rate, emotion, or clinical signal data.

The system may require step-up attestation for high-value licensing packages, cross-chain validation, medical authorizations, or mint-eligibility instructions.

The embodiments described in this section may be combined with any other embodiment described herein unless the combination is technically impossible. Field names, terminal names, endpoint names, and branded names are examples and may be replaced by equivalent machine-readable identifiers.

A claim element corresponding to this section may be implemented as software instructions, hardware circuitry, firmware, a terminal module, a server module, a database table, a ledger entry, an API endpoint, or a distributed combination thereof.

### Scoped Identity Slot Management

The scoped-identity allocator may maintain a slot table in which each scoped identity resource includes a slot number, scope type, policy version, lifecycle state, allowed outputs, expiration rule, revocation rule, and permitted validators.

A slot may be created for communication, another slot for medical services, another for asset licensing, another for wallet operations, another for education, and another for enterprise workflow.

The upper bound of nine hundred ninety-nine scoped resources may be implemented as a policy constraint, database constraint, terminal memory constraint, or namespace constraint.

A root identity may not be exposed to downstream validators. Instead, a validator may receive only a scoped identity reference and a proof that the scoped identity is valid for a requested context.

A slot may be suspended without deleting its audit trail. Suspension may prevent new eligibility records while preserving previously issued records for audit and dispute resolution.

A slot may be transferable only if the policy table permits transfer. Medical, identity-vault, or biometric verification slots may be non-transferable, while asset or licensing slots may permit controlled assignment.

A slot may be linked to one or more terminals. A high-security slot may require two terminals or a terminal plus an institutional credential.

The allocator may prevent slot collision by checking slot number, coordinate hash, root identity hash, policy, and terminal binding before issuing a new slot.

The embodiments described in this section may be combined with any other embodiment described herein unless the combination is technically impossible. Field names, terminal names, endpoint names, and branded names are examples and may be replaced by equivalent machine-readable identifiers.

A claim element corresponding to this section may be implemented as software instructions, hardware circuitry, firmware, a terminal module, a server module, a database table, a ledger entry, an API endpoint, or a distributed combination thereof.

### Time-of-Time Ledger Data Structures

A time-of-time ledger record may include a ledger record identifier, start time, end time, time-window type, prior record hash, terminal proof hash, coordinate hash, scoped identity hash, value-eligibility reference, and audit status.

The ledger may support overlapping windows when a terminal participates in multiple contexts. Each window may maintain a separate policy and eligibility state.

A ledger verifier may reject a record if the prior record hash does not match, if the terminal counter regresses, if the time window is stale, or if the policy version is revoked.

A ledger record may be used as evidence that a terminal-generated behavior state occurred within a particular bounded interval without publishing the raw behavior signal.

The ledger may store zero-knowledge commitments or selective-disclosure credentials rather than raw payloads.

A time-window may have a correction period. During the correction period, revocation or annotation may be permitted. After finality, the record may be closed except under exceptional policy-defined procedures.

A time-of-time ledger can be private to an enterprise or public to a marketplace. Hybrid deployments may anchor private record hashes into a public chain at defined intervals.

The ledger may provide APIs for validation, revocation check, time-window proof retrieval, and audit pointer retrieval.

The embodiments described in this section may be combined with any other embodiment described herein unless the combination is technically impossible. Field names, terminal names, endpoint names, and branded names are examples and may be replaced by equivalent machine-readable identifiers.

A claim element corresponding to this section may be implemented as software instructions, hardware circuitry, firmware, a terminal module, a server module, a database table, a ledger entry, an API endpoint, or a distributed combination thereof.

### Behavior Attestation Without Raw Data Disclosure

A biometric signal may be processed into a liveness score, possession score, or confidence class. The raw biometric template may remain encrypted or terminal-local.

An emotional signal may be processed into a bounded state, confidence score, consent flag, or anomaly indicator without exposing personal emotional content to downstream systems.

An activity signal may include step continuity, service use, terminal use, communication presence, medical sensor activity, or signed user interaction.

A behavior-attestation state may be computed by a rule engine, machine learning model. threshold evaluator, cryptographic proof verifier, or hybrid validator.

The verifier may produce a proof-only state when behavior confidence is sufficient for audit but not sufficient for mint eligibility or transfer eligibility.

The verifier may require multiple independent signals for high-value outputs. For example, liveness, terminal possession, time continuity, and absence of anomaly may all be required for a licensing transfer.

The verifier may classify signals into eligible, ineligible, review-required, restricted, or expired states.

Downstream systems may receive only the derived state, proof hash, policy version, and expiry time, thereby reducing privacy risk.

The embodiments described in this section may be combined with any other embodiment described herein unless the combination is technically impossible. Field names, terminal names, endpoint names, and branded names are examples and may be replaced by equivalent machine-readable identifiers.

A claim element corresponding to this section may be implemented as software instructions, hardware circuitry, firmware, a terminal module, a server module, a database table, a ledger entry, an API endpoint, or a distributed combination thereof.

### Eligibility Records and Economic Safety

A value-eligibility record may be designed as a technical authorization that is separate from actual currency, securities, banking, or payment movement.

An eligibility record may include record identifier, coordinate hash, scoped identity hash, terminal attestation hash, time-window hash, behavior state, policy version, permitted operation, expiration time, and revocation status.

The permitted operation may be mint eligibility, service credit eligibility, communication credit eligibility, medical service eligibility, licensing eligibility, transfer eligibility, marketplace listing eligibility, or index eligibility.

The system may produce a denial record when eligibility fails. A denial record may identify a technical reason such as stale time proof, invalid terminal attestation, revoked scoped identity, duplicate proof, or anomaly threshold failure.

A value-eligibility record may be locked to a specific asset or service context so that it cannot be replayed for an unrelated transaction.

The eligibility record may be consumed by a downstream transaction. After consumption, the anti-replay controller may mark the record as consumed and reject duplicate use.

Eligibility records may be stored in an audit vault so that later licensees, assignees, auditors, or acquirers can validate transaction history.

The system can improve asset-package valuation by attaching technical validation records to licensing rights, identity rights, service rights, or asset-transfer rights.

The embodiments described in this section may be combined with any other embodiment described herein unless the combination is technically impossible. Field names, terminal names, endpoint names, and branded names are examples and may be replaced by equivalent machine-readable identifiers.

A claim element corresponding to this section may be implemented as software instructions, hardware circuitry, firmware, a terminal module, a server module, a database table, a ledger entry, an API endpoint, or a distributed combination thereof.

### Asset Package and Transfer Utility

A patent asset may be linked to a coordinate identifier, scoped identity resource, inventor identity proof, terminal attestation hash, document hash, time-window proof, and licensing policy.

A licensing package may include field-of-use restrictions, territory restrictions, term restrictions, exclusivity status, sublicensing rules, royalty triggers, audit rules, and revocation conditions.

A transfer package may include chain-of-title pointer, coordinate hash, identity-scope proof, authorized-signatory proof, asset pointer, anti-duplication check, and finality condition.

The system may generate due-diligence exports in which a buyer validates the proofs without receiving raw private terminal data.

A marketplace-listing signal may indicate that an asset has a valid coordinate, active scoped identity, unexpired time proof, and clean anti-replay state.

A licensee may validate a licensing package through an API and receive a signed response stating valid, expired, revoked, restricted, disputed, or review-required.

The asset package may include multiple patents, each associated with different scoped identity resources and eligibility records.

This structure supports cross-licensing, assignment, collateralization, valuation, and financing without reducing the invention to a pure financial transaction.

The embodiments described in this section may be combined with any other embodiment described herein unless the combination is technically impossible. Field names, terminal names, endpoint names, and branded names are examples and may be replaced by equivalent machine-readable identifiers.

A claim element corresponding to this section may be implemented as software instructions, hardware circuitry, firmware, a terminal module, a server module, a database table, a ledger entry, an API endpoint, or a distributed combination thereof.

### Medical, Communication, and Enterprise Use Cases

In a telehealth use case, a patient terminal and provider terminal may each generate attestation proofs and scoped identity references before a medical minute, service record, or authorization is recognized.

In a communication use case, a message or session may be routed by coordinate identifier and bound to a time-window proof without requiring a conventional telephone number.

In an enterprise use case, an employee or contractor may receive separate scoped identities for finance, engineering, health, and asset-management workflows.

In a marketplace use case, a seller may list an asset only when the asset-tagging record and value-eligibility record are active and not revoked.

In a device mesh use case, sensors or machines may generate terminal proofs and service signals that are bound to coordinate identifiers and time-of-time ledger records.

In an AI-agent use case, the agent may be treated as a terminal or service node requiring scoped authority and time-bounded eligibility.

In a public-benefit use case, verified time and behavior states may support non-transferable service credits or reputation records.

In each use case, the claimed technical gates are the same: coordinate, terminal, scoped identity, time, behavior, eligibility, anti-replay, and output.

The embodiments described in this section may be combined with any other embodiment described herein unless the combination is technically impossible. Field names, terminal names, endpoint names, and branded names are examples and may be replaced by equivalent machine-readable identifiers.

A claim element corresponding to this section may be implemented as software instructions, hardware circuitry, firmware, a terminal module, a server module, a database table, a ledger entry, an API endpoint, or a distributed combination thereof.

### API and Validation Responses

A validation API may receive a value-eligibility record identifier, coordinate hash, asset pointer, scoped identity reference, nonce, and validator credential.

The API may return a validation status, expiry time, permitted operation, policy version, revocation state, and audit pointer.

The API may withhold root identity, raw biometric data, raw emotional data, private terminal payloads, medical records, or confidential documents.

A validator may be a marketplace, exchange, registry, licensee, assignee, health-service provider, communication service, government agency, enterprise system, or wallet provider.

The API may implement rate limits, role-based permissions, jurisdiction filters, consent checks, and purpose limitations.

Validation responses may be signed so that third parties can rely on them in a transaction package.

A validation response may be cached only within a bounded time window, after which a new validation request is required.

The API may return a correction or revocation notice if a prior validation was superseded by later terminal compromise, identity conflict, or policy change.

The embodiments described in this section may be combined with any other embodiment described herein unless the combination is technically impossible. Field names, terminal names, endpoint names, and branded names are examples and may be replaced by equivalent machine-readable identifiers.

A claim element corresponding to this section may be implemented as software instructions, hardware circuitry, firmware, a terminal module, a server module, a database table, a ledger entry, an API endpoint, or a distributed combination thereof.

### Security Architecture

Security may be implemented through public-key cryptography, passkeys, hardware security modules, secure enclaves, encrypted vaults, trusted execution environments, secure boot, signed firmware, attestation certificates, and append-only logs.

Keys may be rotated according to policy. A key rotation may update terminal attestation records and require revalidation of active scoped identities.

Sensitive data may be stored as encrypted blobs with hash pointers. A downstream system may only receive a hash and validation state.

A compromised terminal may be isolated without disabling unrelated terminals or scoped identities.

The system may support recovery procedures using institutional credentials, backup terminals, social recovery, court order, medical provider attestation, or enterprise administrator approval.

Recovery procedures may create a correction record rather than deleting history.

The system may implement least-privilege access so that a validator only sees the scoped identity and eligibility state relevant to its role.

All high-value outputs may require freshness checks to prevent stale validation responses from being used in later transfers.

The embodiments described in this section may be combined with any other embodiment described herein unless the combination is technically impossible. Field names, terminal names, endpoint names, and branded names are examples and may be replaced by equivalent machine-readable identifiers.

A claim element corresponding to this section may be implemented as software instructions, hardware circuitry, firmware, a terminal module, a server module, a database table, a ledger entry, an API endpoint, or a distributed combination thereof.

### Patentability-Focused Technical Effects

The system produces a specific improvement in computer identity management by structuring identity into scoped resources bound to coordinate, terminal, time, and behavior states.

The system produces a specific improvement in anti-replay processing by linking nonces, terminal counters, consumed-proof states, and time-window ledger records.

The system produces a specific improvement in privacy by enabling validation of eligibility without transmission of raw biometric, emotional, medical, or terminal payload data.

The system produces a specific improvement in asset registry technology by binding assets to coordinate identifiers, terminal attestations, scoped identity resources, time-window proofs, and revocation states.

The system produces a specific improvement in terminal security by requiring secure-enclave or device-certificate attestation before eligibility records are generated.

The system produces a specific improvement in distributed transaction reliability by producing signed licensing and transfer packages from technical proof states.

The system is not limited to a mathematical formula, business method, or mental process because the claimed operations require specific machine-generated proofs, terminal data, ledger records, and computer-enforced rejection states.

The modules cooperate in a state-dependent sequence, so the output cannot be produced by a mere aggregation of unrelated known components.

The embodiments described in this section may be combined with any other embodiment described herein unless the combination is technically impossible. Field names, terminal names, endpoint names, and branded names are examples and may be replaced by equivalent machine-readable identifiers.

A claim element corresponding to this section may be implemented as software instructions, hardware circuitry, firmware, a terminal module, a server module, a database table, a ledger entry, an API endpoint, or a distributed combination thereof.

### DRAWING-SPECIFIC OPERATIONAL SUPPORT

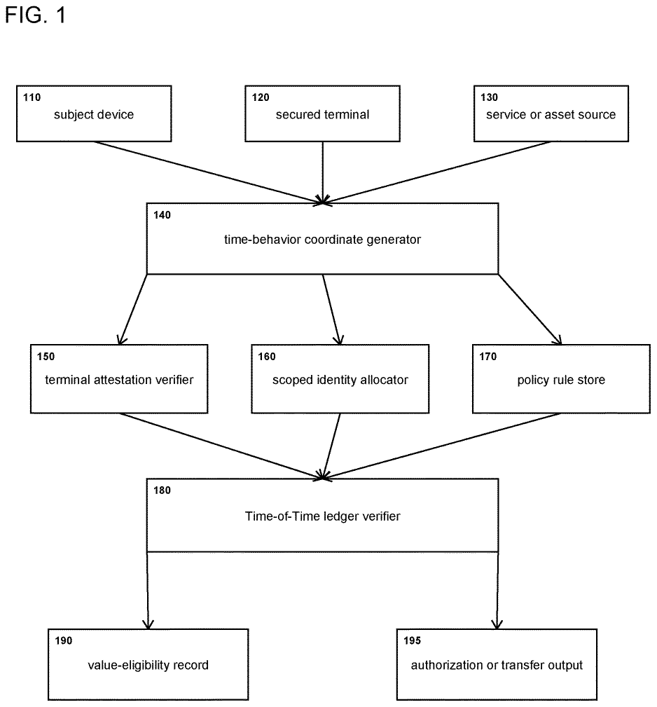

In FIG. 1, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

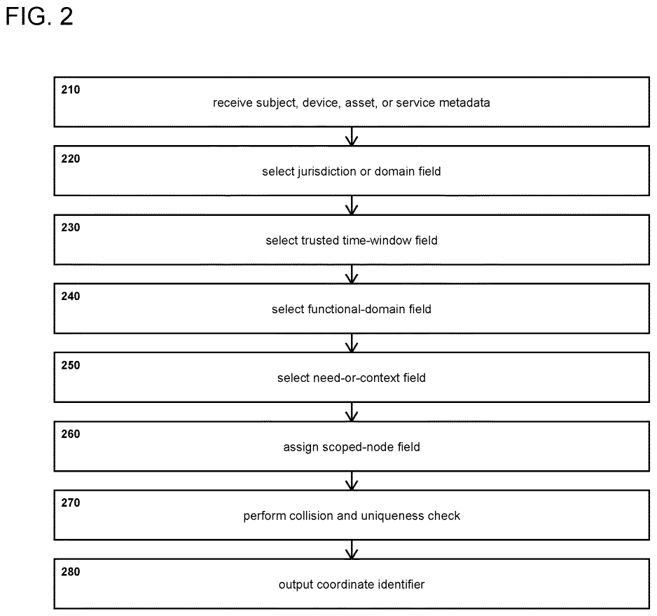

In FIG. 2, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

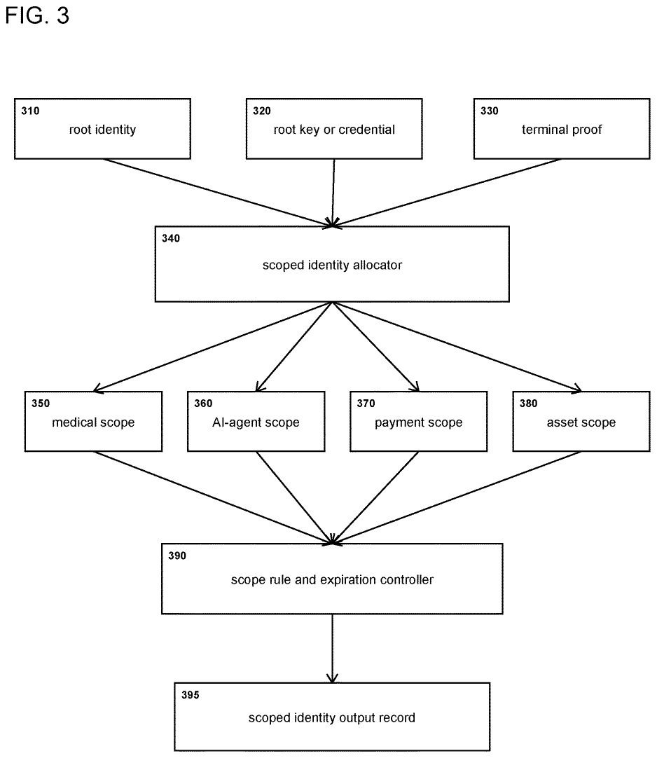

In FIG. 3, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

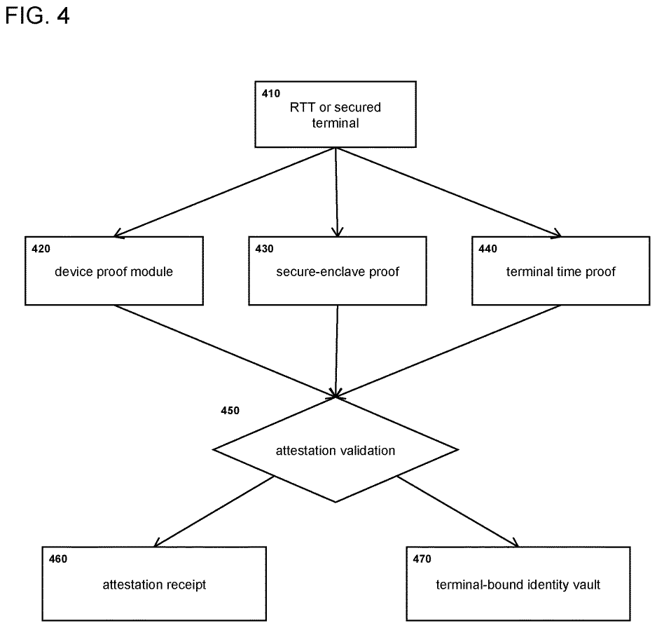

In FIG. 4, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

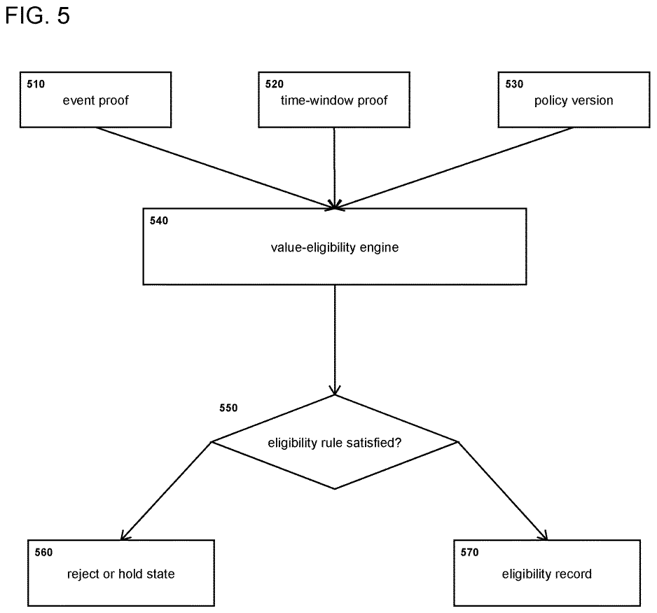

In FIG. 5, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

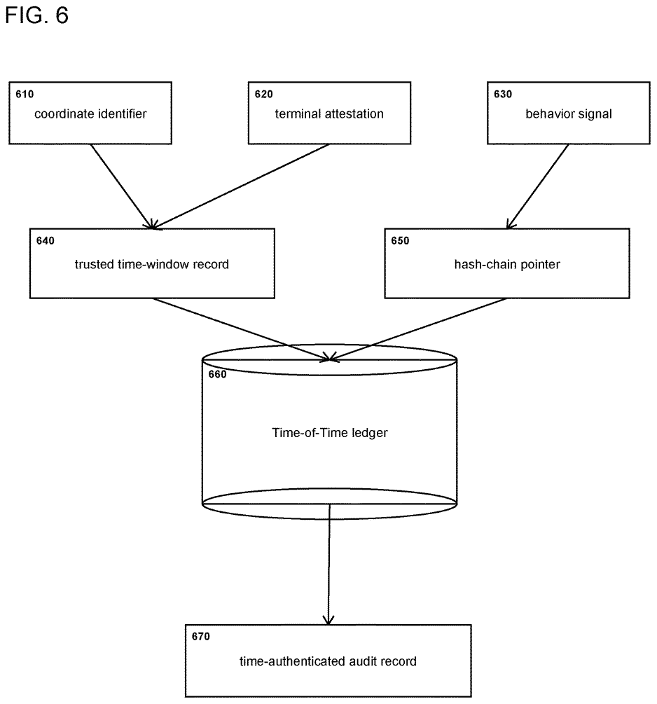

In FIG. 6, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

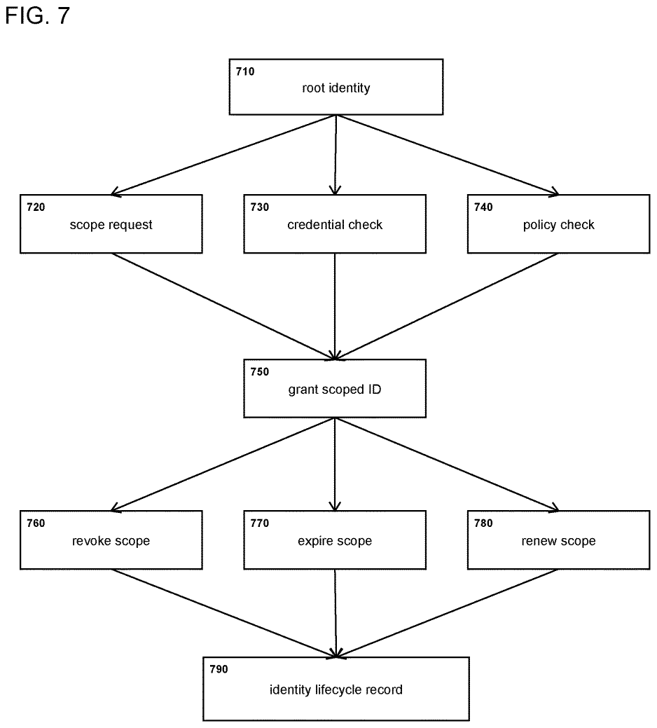

In FIG. 7, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

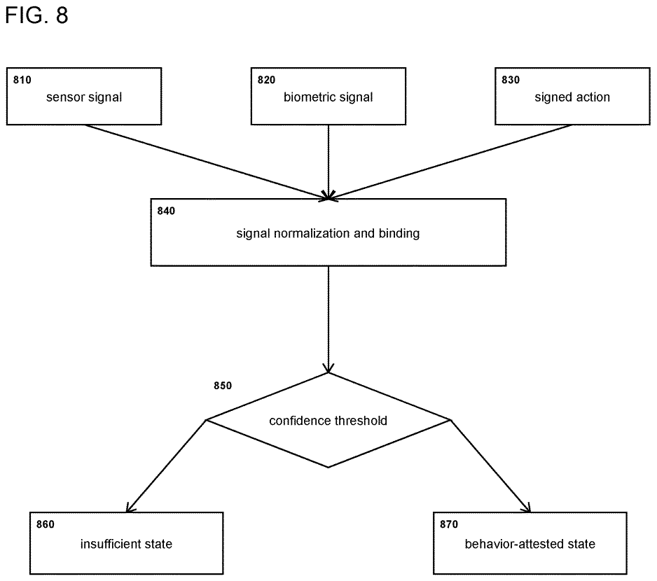

In FIG. 8, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

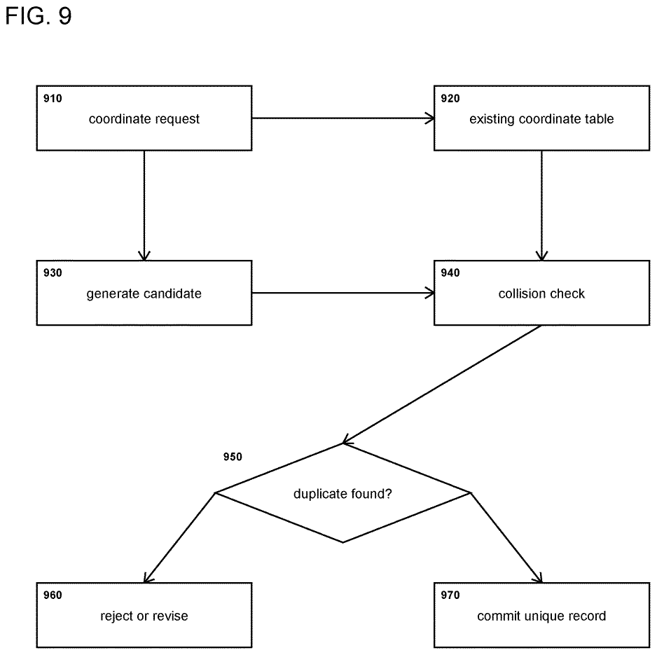

In FIG. 9, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity. time, behavior, eligibility, and output architecture.

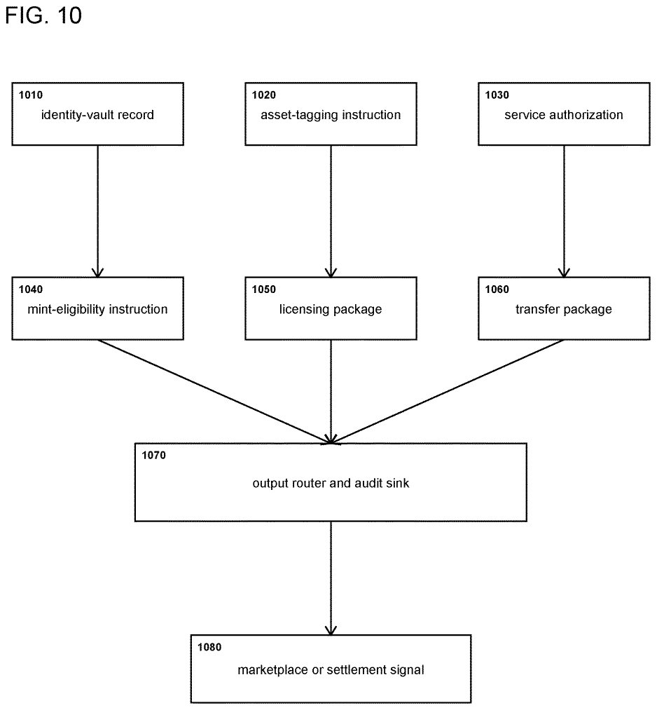

In FIG. 10, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

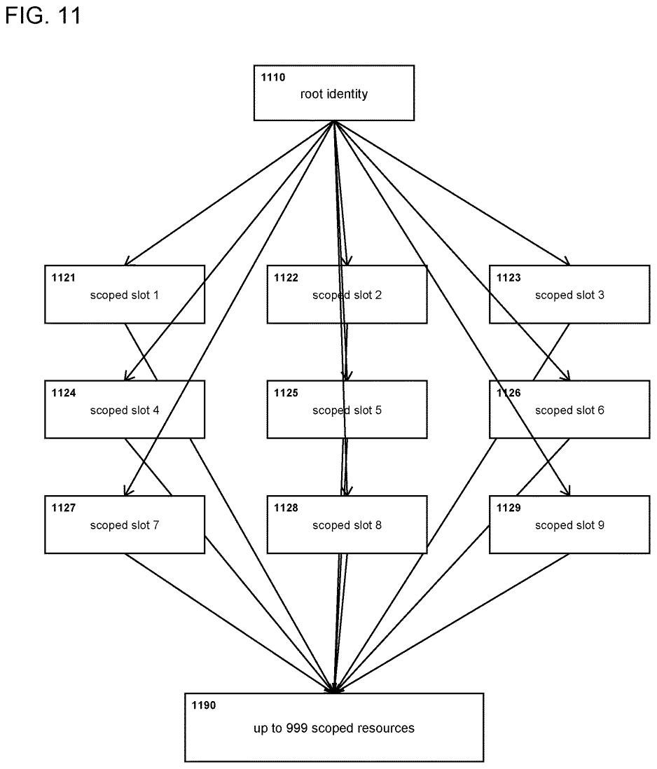

In FIG. 11, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

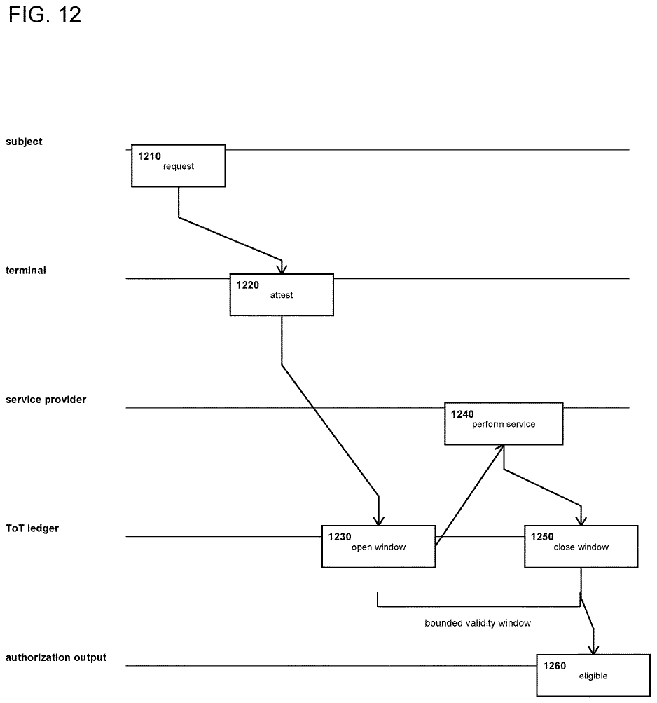

In FIG. 12, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

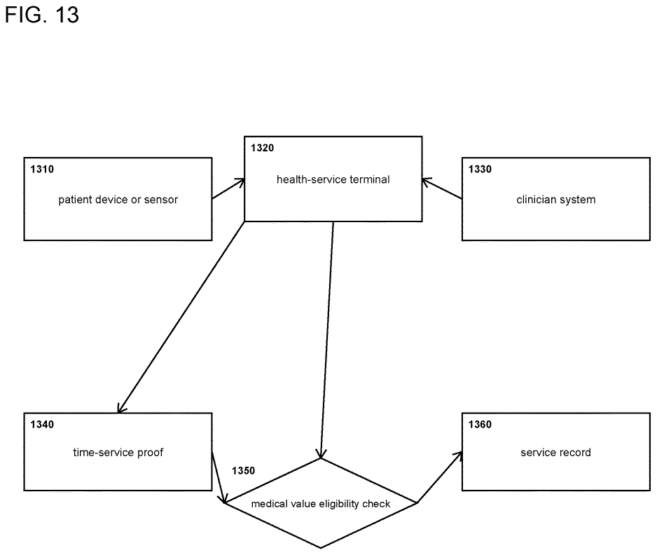

In FIG. 13, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

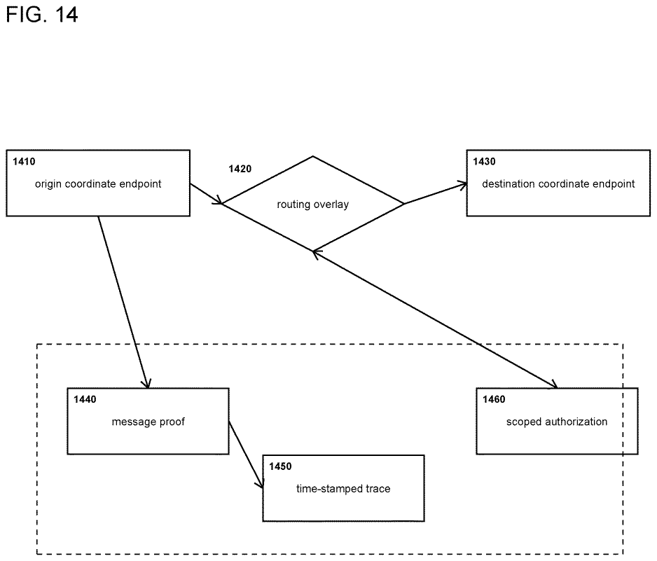

In FIG. 14, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

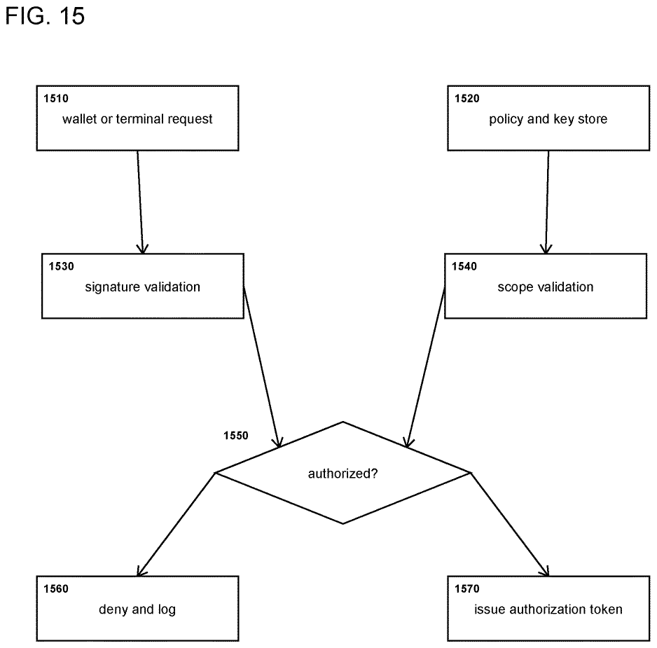

In FIG. 15, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

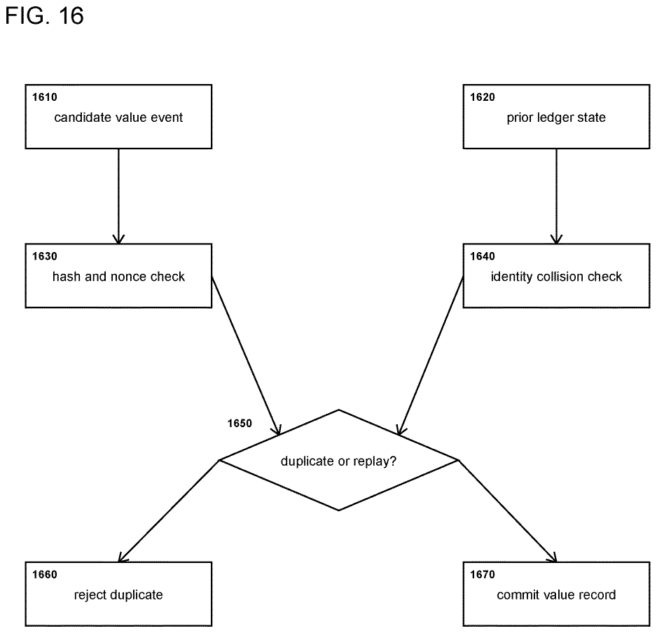

In FIG. 16, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

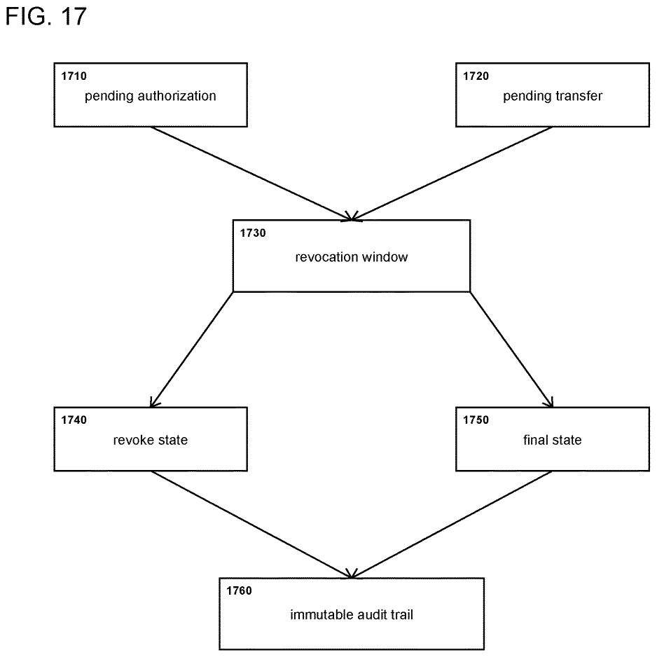

In FIG. 17, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

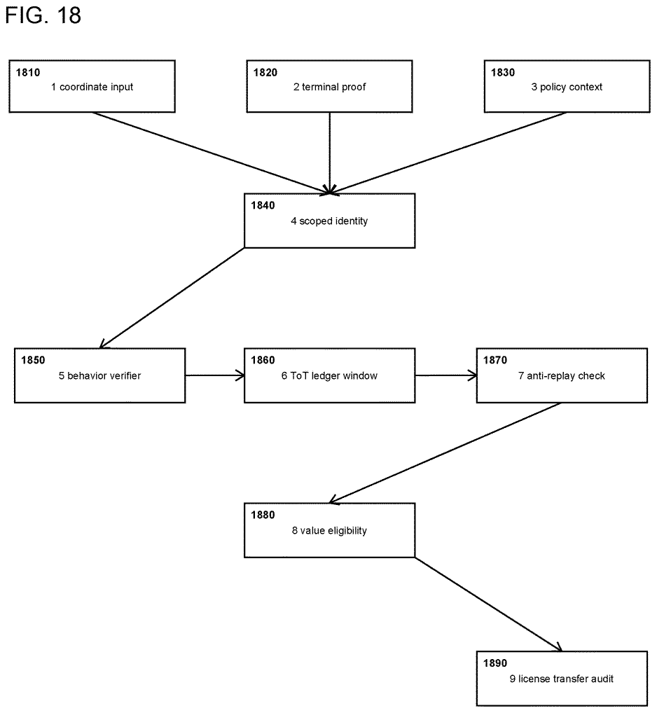

In FIG. 18, the illustrated blocks may be implemented as separate services, microservices, software modules, hardware modules, cloud components, terminal components, smart-contract components, or integrated components. Arrows represent logical data flow and need not require direct physical connection.

The figure is intended to show one state-dependent operating relationship. Alternative embodiments may add intermediate validation, caching, policy enforcement, encryption, attestation, or audit steps without departing from the disclosed coordinate, terminal, identity, time, behavior, eligibility, and output architecture.

### ADDITIONAL CLAIM MAPPING

Claim 1 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 2 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 3 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 4 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 5 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 6 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 7 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 8 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 9 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 10 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 11 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 12 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 13 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 14 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 15 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 16 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 17 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 18 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 19 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

Claim 20 is supported at least by the disclosed modules, data objects, operating sequences, and alternative embodiments that describe coordinate generation, terminal attestation, scoped identity lifecycle control, time-window ledger binding, behavior-state verification, value-eligibility generation, anti-replay rejection, asset tagging, licensing package creation, transfer package creation, validation APIs, privacy-preserving responses, and revocation or audit signals.

### DOMAIN-NODE IMPLEMENTATION AND OPERATING USE CASES

In non-limiting embodiments, a time-of-time ledger service may be implemented through a domain node, application endpoint, institutional endpoint, device endpoint, terminal endpoint, local database endpoint, cloud service endpoint, distributed service endpoint, or API endpoint. The endpoint may expose interfaces for creating trusted time-window records, receiving terminal time proofs, binding coordinate identifiers, verifying consumed-proof states, checking replay status, issuing eligibility records, and returning audit responses. The same technical operations may be performed without using a public domain name.

A Time ID or Time Identity application endpoint may provide enrollment, wallet, terminal-registration, scoped-identity management, authorization-window review, credential display, revocation notification, and validation-request functions. The application endpoint is not required to be the ledger itself; it may operate as a user interface, terminal interface, identity vault interface, service authorization interface, developer interface, or validator interface for the underlying time-behavior coordinate infrastructure.

In one operating sequence, a secured terminal creates a terminal time proof for a service session. The time-of-time ledger receives a terminal identifier, trusted time-window value, counter, nonce, coordinate reference, scoped identity reference, and behavior-attestation state. The ledger rejects replayed terminal proofs, duplicate time-window claims, expired authorization windows, or conflicting scoped identity resources. When validation succeeds, the ledger returns a signed time-window verification record to the value-eligibility engine.

In a medical or health-service implementation, a patient, clinician, sensor, or telehealth terminal may use a Time ID interface to bind a medical service session to a scoped medical identity, terminal attestation, and trusted time window. The time-of-time ledger may produce a service-minute proof, care-window proof, remote-monitoring proof, medication-observance proof, or medical authorization-window proof without exposing raw biometric or clinical payloads. The resulting eligibility record may support reimbursement review, quality audit, licensing, care coordination, or downstream value conversion.

In an AI-agent authorization implementation, a user may authorize an AI agent only for a bounded time window, bounded task scope, bounded endpoint, bounded data class, or bounded value action. The Time ID interface may display the authorized scope, while the time-of-time ledger verifies that the AI agent request occurs within the trusted window and has not reused a prior terminal proof or authorization nonce. The output may be an agent-authorization proof, denial state, escalation state, revocation state, or value-eligibility record.

In an intellectual-property implementation, an inventor, assignee, attorney, publication node, or disclosure terminal may bind a patent disclosure, figure set, claim set, laboratory record, domain asset, source file, or licensing package to a coordinate identifier and time-window proof. The time-of-time ledger may store or verify a disclosure hash, inventor identity proof, scoped disclosure identity, publication window, licensing window, revocation state, and finality state. A marketplace or licensee may later validate the proof through an API without receiving confidential raw documents.

In an asset-package implementation, one or more deployment, explanation, validation, developer, or transaction portals may route to the same underlying coordinate, terminal-attestation, scoped-identity time-ledger behavior-verification, eligibility, licensing, transfer, and audit infrastructure. The rights are not limited to any portal name or domain name and may be implemented through equivalent application names, service names, private endpoints, enterprise endpoints, institutional endpoints, or machine-resolvable identifiers.

In a developer or enterprise integration, the ledger endpoint may expose API calls such as createTimeWindow, verifyTerminalTime, bindTimeIdentity, allocateScopedIdentity, verifyBehaviorState, issueEligibilityRecord, validateNoReplay, revokeScopedIdentity, exportAuditRecord, and closeFinality Window. Equivalent API names, message formats, database procedures, smart contract calls, service-bus events, secure enclave calls, or ledger transactions may implement the same technical functions.

In a licensing and transfer use case, a licensee may receive a package containing a coordinate proof, Time ID proof, terminal proof, time-of-time ledger proof, behavior-state proof, scoped identity proof, value-eligibility record, revocation endpoint, royalty-audit endpoint, and transfer-status endpoint. This allows the licensee to confirm that the asset is active, the identity resource is in scope, the authorization window remains valid, and the value record has not been duplicated, replayed, revoked, or closed.

In a standards or consortium use case, a Time Identity organization endpoint may publish non-confidential schemas, developer documentation, validator interfaces, audit formats, credential profiles, or protocol examples. Such publication does not convert the invention into an abstract standard; the protected implementation requires state-dependent machine operations for coordinate generation, terminal attestation, scoped identity allocation, trusted time-window verification, behavior-state verification, value-eligibility issuance, anti-replay control, and revocation or finality control.

### TRANSACTIONAL ASSET PACKAGE EMBODIMENTS

The infrastructure may be organized as a transaction-ready asset package in which each patent, patent disclosure, software module, terminal design, identity namespace, endpoint, and marketplace right is associated with a coordinate reference, scoped identity resource, time-window proof, and validation endpoint.

A purchaser, licensee, lender, marketplace operator, or auditor may review a package export that contains signed validation responses, redacted proof objects, revocation states, asset pointers, coordinate hashes, and lifecycle states. The export can support valuation without requiring disclosure of private biometric, emotional, medical, or terminal data.

A package may divide rights into coordinate issuance rights, terminal manufacturing rights, identity-vault rights, time-ledger validation rights, behavior-verification rights, value-eligibility rights, asset-tagging rights, marketplace-listing rights, and validation-API rights. Each right can be licensed separately.

The same technical proof chain can be reused for diligence, royalty auditing, sublicensing, asset transfer, financing, and enforcement because the proof chain is linked to terminal, time, identity, and anti-replay states.

A transfer package may include representations that a coordinate is active, a scoped identity is valid, a terminal proof is fresh, a time-window record is unexpired, and no duplicate eligibility record has been consumed. These are technical validations rather than mere contractual statements.

The asset package may also include revocation interfaces so that a licensee or assignee receives updated status when a terminal is compromised, a scoped identity expires, a policy changes, or a coordinate is replaced.

This packaging structure increases commercial utility because it allows the same protected technology to be monetized through platform licenses, device licenses, API licenses, data-vault licenses, registry licenses, and asset-marketplace licenses.

The invention therefore protects hard transaction choke points: coordinate issuance, terminal attestation, scoped identity slot assignment, time-window binding, behavior-state derivation, eligibility issuance, duplicate rejection, package validation, and revocation-state publication.

### ENFORCEMENT AND DESIGN-AROUND RESISTANCE

A system may attempt to avoid a branded identity name while still using a jurisdiction-time-domain-context-node coordinate, a terminal attestation, a scoped identity resource, a trusted time ledger, and behavior-state based eligibility. Such a system would still perform the technical relationship described herein if the claimed elements are present.

A system may attempt to replace biometric signals with device-possession or service signals. The claims are written to cover sensor, biometric, activity, terminal-use, communication, service, or signed-action signals according to the selected claim language.

A system may attempt to replace the time-of-time ledger with a database or private log. The disclosure supports any append-only, chained, or verifiable time-window record system when it performs the claimed trusted time-window binding function.

A system may attempt to issue a token directly instead of an eligibility record. The disclosure covers eligibility outputs, mint-eligibility instructions, service authorizations, licensing packages, transfer packages, marketplace signals, and audit records, allowing protection at upstream technical gates.

A system may attempt to use ordinary account IDs. The scoped identity allocation features require bounded resources, lifecycle states, revocation rules, and context-limited permissions, which provide a separate technical layer.

A system may attempt to route by existing endpoints such as wallet addresses, domain names, or phone numbers. The coordinate resolver can map to such endpoints while preserving the coordinate, terminal, time, identity, and eligibility proof chain.

A system may attempt to validate externally through an API. The validation API embodiments expressly support third-party validation without raw private data disclosure.

The claim set is intended to create cross-sectional coverage across system, method, and computer-readable medium categories so that software platforms, terminal providers, registry services, marketplace services, and validation services can each be evaluated for licensing.

### FURTHER NON-LIMITING EXAMPLES

In example 1, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 2, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 3, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 4, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 5, a coordinate identifier may be generated for a distinct asset, service, terminal, user context, institutional context, medical context, communication context marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 6, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 7, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 8, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 9, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 10, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 11, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 12, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 13, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 14, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 15, a coordinate identifier may be generated for a distinct asset, service, terminal, user context, institutional context, medical context communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 16, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 17, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 18, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 19, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 20, a coordinate identifier may be generated for a distinct asset, service, terminal, user context, institutional context, medical context, communication context marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 21, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 22, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 23, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 24, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 25, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 26, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 27, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 28, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 29, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 30, a coordinate identifier may be generated for a distinct asset, service, terminal, user context, institutional context, medical context, communication context marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 31, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.
In example 32, a coordinate identifier may be generated for a distinct asset, service, terminal, user context, institutional context, medical context, communication context, marketplace context, or licensing context. The system verifies terminal attestation, binds the scoped identity to a trusted time-window record, derives an attestation state from permitted signals, checks for replay and collision, and then outputs only the technical authorization, package, validation, or revocation signal permitted by policy.

What is claimed is:

1. A computer-implemented sovereign time-behavior coordinate system comprising: a coordinate-identifier generator configured to generate, for a subject, device, asset, service, or terminal, a multidimensional coordinate identifier including at least a jurisdiction field, a trusted time-window field, a functional-domain field, a need-or-context field, and a scoped node field; a terminal-attestation interface configured to receive, from a secured terminal, terminal attestation data including a terminal identifier, a device certificate or secure-enclave attestation, and a terminal time proof; a scoped-identity allocator configured to assign, update, suspend, or revoke one or more scoped identity resources associated with the coordinate identifier, wherein each scoped identity resource is limited to a defined function, service, domain, asset class, medical context, communication context, financial context, or authorization context; a time-of-time ledger interface configured to store or verify a chained sequence of trusted time-window records associated with the coordinate identifier and the secured terminal; a behavior-signal verifier configured to derive a behavior-attestation state from at least one sensor signal, biometric signal, activity signal, terminal-use signal, communication signal, service signal, or cryptographically signed user action; a value-eligibility engine configured to generate a value-eligibility record only after the coordinate identifier, terminal attestation data, scoped identity resource, trusted time-window record, and behavior-attestation state satisfy one or more machine-readable eligibility rules; an anti-replay and collision controller configured to prevent duplicate coordinate assignment, duplicate scoped-identity issuance, replay of terminal time proofs, or duplicate value-eligibility records; and an output interface configured to transmit at least one of an identity-vault record, asset-tagging instruction, communication-routing instruction, service-authorization instruction, mint-eligibility instruction, licensing package, transfer package, marketplace-listing signal, audit record, or revocation signal.

2. The system of claim 1, wherein the coordinate-identifier generator normalizes the jurisdiction field, trusted time-window field, functional-domain field, need-or-context field, and scoped node field into a routable alphanumeric coordinate string, and wherein the multidimensional coordinate identifier is configured to operate as a routing, authorization, identity, service, asset, licensing, transfer, or settlement reference in place of, or in addition to, a telephone number, SIM credential, bank routing identifier, platform account identifier, or GPS-dependent location reference.

3. The system of claim 1, wherein the secured terminal comprises a ReadName Token Terminal including a biometric sensor interface, local cryptographic key store, secure enclave, terminal clock, network interface, and identity-vault memory.

4. The system of claim 1, wherein the scoped-identity allocator allocates up to nine hundred ninety-nine scoped identity resources for a root identity while enforcing a separate policy, lifecycle state, and revocation rule for each scoped identity resource.

5. The system of claim 1, wherein the time-of-time ledger interface records a time-window hash, prior-window hash, terminal signature, policy version, and coordinate-reference hash for each trusted time-window record.

6. The system of claim 1, wherein the behavior-signal verifier generates a confidence score or behavior-attestation state using a deterministic, probabilistic, cryptographic, hardware-based, rule-based, threshold-based, fuzzy-logic, statistical, graph-based, machine-learning, or hybrid verification technique applied to at least one of biometric liveness, device possession, activity continuity, terminal attestation, zero-knowledge proof, service-completion status, or anomaly-detection output.

7. The system of claim 1, wherein the value-eligibility record is a non-currency technical authorization record that indicates eligibility for a later minting, service-credit, licensing, asset-transfer, settlement, or index operation without itself moving legal tender.

8. The system of claim 1, wherein the anti-replay and collision controller uses a consumed-proof state, nonce set, time-window boundary, terminal counter, coordinate hash, and scoped-identity status to reject replayed or duplicated requests.

9. The system of claim 1, wherein the output interface writes a privacy-preserving audit record containing a redacted event pointer, terminal attestation hash, coordinate hash, and value-eligibility state.

10. A computer-implemented method for operating a sovereign time-behavior coordinate infrastructure, the method comprising: receiving, by one or more processors, a request from a secured terminal for a subject, device, asset, service, or terminal; generating a multidimensional coordinate identifier including a jurisdiction field, trusted time-window field, functional-domain field, need-or-context field, and scoped node field; verifying terminal attestation data comprising a terminal identifier, device certificate or secure-enclave attestation, and terminal time proof; assigning a scoped identity resource to the coordinate identifier according to a machine-readable allocation rule; binding the scoped identity resource to a trusted time-window record in a time-of-time ledger; deriving a behavior-attestation state from at least one sensor signal, biometric signal, activity signal, terminal-use signal, communication signal, service signal, or cryptographically signed user action; determining, by a value-eligibility engine, whether the coordinate identifier, terminal attestation data, scoped identity resource, trusted time-window record, and behavior-attestation state satisfy one or more eligibility rules; generating a value-eligibility record when the eligibility rules are satisfied; rejecting a request when duplicate coordinate assignment, duplicate scoped-identity issuance, replay of terminal time proofs, or duplicate value-eligibility records is detected; and transmitting at least one of an identity-vault record, asset-tagging instruction, communication-routing instruction, service-authorization instruction, mint-eligibility instruction, licensing package, transfer package, marketplace-listing signal, audit record, or revocation signal.

11. The method of claim 10, further comprising converting the multidimensional coordinate identifier into a routable endpoint usable by a communication service, identity service, asset registry, medical service, wallet, marketplace, or licensing system.

12. The method of claim 10, further comprising generating a confidence score or behavior-attestation state using a deterministic, probabilistic, cryptographic, hardware-based, rule-based, threshold-based, fuzzy-logic, statistical, graph-based, machine-learning, or hybrid verification technique before generating the value-eligibility record.

13. The method of claim 10, further comprising assigning each scoped identity resource a lifecycle state selected from pending, active, restricted, suspended, revoked, expired, transferred, licensed, disputed, or closed.

14. The method of claim 10, further comprising generating an asset-tagging instruction that binds a patent disclosure, communication endpoint, service record, digital asset, domain asset, medical record pointer, or terminal record to the multidimensional coordinate identifier.

15. The method of claim 10, further comprising generating a revocation signal when the secured terminal reports compromise, sensor failure, policy expiration, identity conflict, or unauthorized replay.

16. The method of claim 10, wherein the trusted time-window record is used to determine a bounded validity window for a service authorization, identity assertion, asset-tagging instruction, or mint-eligibility instruction.

17. A non-transitory computer-readable medium storing instructions that, when executed by one or more processors, cause the one or more processors to perform operations comprising: generating a multidimensional coordinate identifier including a jurisdiction field, trusted time-window field, functional-domain field, need-or-context field, and scoped node field; verifying terminal attestation data from a secured terminal; allocating a scoped identity resource associated with the multidimensional coordinate identifier; binding the scoped identity resource to a trusted time-window record in a time-of-time ledger; deriving a behavior-attestation state from a sensor signal, biometric signal, activity signal, terminal-use signal, communication signal, service signal, or cryptographically signed user action; generating a value-eligibility record only when the multidimensional coordinate identifier, terminal attestation data, scoped identity resource, trusted time-window record, and behavior-attestation state satisfy one or more eligibility rules; rejecting a request when duplicate coordinate assignment, duplicate scoped-identity issuance, replay of terminal time proofs, or duplicate value-eligibility records is detected; and transmitting at least one of an identity-vault record, asset-tagging instruction, communication-routing instruction, service-authorization instruction, mint-eligibility instruction, licensing package, transfer package, marketplace-listing signal, audit record, or revocation signal.

18. The non-transitory computer-readable medium of claim 17, wherein the instructions cause the one or more processors to maintain a policy table defining eligibility thresholds for different functional-domain fields.

19. The non-transitory computer-readable medium of claim 17, wherein the instructions cause the one or more processors to generate a licensing package including a coordinate reference, scoped identity resource, asset pointer, value-eligibility state, time-window proof, and revocation condition.

20. The non-transitory computer-readable medium of claim 17, wherein the instructions cause the one or more processors to expose an application programming interface through which a third-party system validates the value-eligibility record without receiving raw biometric data, raw behavioral data, or private terminal payloads.
